(19) United States
(12) Patent Application Publication
(10) Pub. No.: US 2022/0187684 A1
(43) Pub. Date: Jun. 16, 2022

(54) EXTERNAL LIGHT SOURCE FOR MOBILE DEVICES

(71) Applicant: PROFOTO AKTIEBOLAG, Sundbyberg (SE)

(72) Inventors: Marko PIRC, Mirna Pec (SI); Jure LAJLAR, Celje (SI); Jure NOVAK, Mirna (SI); Gaja ZORNADA, Ljubljana (SI)

(21) Appl. No.: 17/603,317

(22) PCT Filed: Apr. 15, 2020
(86) PCT No.: PCT/SE2020/050389

§ 371 Date: Oct. 12, 2021

(30) Foreign Application Priority Data
Apr. 15, 2019 (SI) 201900080

(51) Int. Cl. G03B 15/05; G08C 17/02

(52) U.S. Cl. CPC G03B 15/05; G03B 2215/0567; G03B 2215/0514; G08C 17/02

(57) ABSTRACT

an external light source is designed as an external flashgun for mobile devices consisting of a xenon flash tube with associated electronic circuitry, whereby the external light source is arranged to operate in at least two modes, in the single flash mode and in the apparent uniform flash mode. The mode of the external light source's operation is set automatically based on the exposure time set on the linked mobile device. One or several external light source are arranged to connect to a mobile device via a radio link, whereby the external light source sends timestamps to the linked mobile device in regular intervals via the radio link. Based on the timestamps, an algorithm in the software running on the mobile device calculates the time delay between the moment photo capture starts on the mobile device and the moment of the flash of light being triggered by the external light source, resulting in the entire frame/subject/scene being uniformly lighted.

### FIELD OF TECHNOLOGY

The present invention falls into the field of devices or systems for the capture of photographs, more precisely in the field of special processes and devices for the capture of photographs, most particularly linked to lighting. The invention refers to a light source or multiple light sources to be used predominantly in photography with mobile devices, and to a method of lighting subjects or scenes to capture photographs.

### BACKGROUND

A flash is one of the key components of cameras of various types, either compact, single-lens reflect, analogue or built into mobile devices, such as mobile telephones and tablet computers, making it possible to take photographs of poorly lighted subjects or scenes. A flash unit may be integrated into the camera or mobile device but may also be used as an independent external unit to be mounted onto a camera or synchronized with it. Integrated flashes are mostly less capable than external units. Often, this requires an additional light source, preferably an additional flash, in order to reach optimum illumination of subjects or scenes.

External flashguns are typically intended for use with (digital) single-lens reflect (DSLR) and mirrorless cameras using mechanical shutters to capture photographs. In the cases of photographs being captured by using exposure times longer than sync speed/X-sync speed, typically 1/250s, the shutters will at a given point in time expose the entire surface of the sensor; therefore, to allow for appropriate lighting of the subject or scene, a single flash of light triggered at the correct time will suffice. In the cases of photographs captured at exposure times shorter than the sync speed, the shutter will travel over the sensor by only exposing a part of the sensor.

In mobile devices, the process of capturing photographs is conceptually very similar to photography using mechanical shutters—a mobile device's camera captures images using a CMOS sensor with an electronic rolling shutter. The sensor scans row after row and the total duration of scanning of all rows (or lines) is called the sensor's reading-out time.

The currently available solutions with a classic or single flash enable uniform illumination of the photograph only when there is an exposure window, which is when at a given point in time the entire area of the CMOS sensor integrates incoming light. The duration of the exposure equals exposure window minus the sensor's reading-out time and buffer time that must be taken into consideration because of incomplete time synchronization between the light source and the sensor. If the flash is not triggered within the exposure window or if there is no exposure window, the photograph's lighting is not optimal, and a portion of the photograph may be completely dark.

Light-emitting diodes (LEDs) are most often used to provide additional lighting in mobile device photography, but they have disadvantages such as low power output and a low color reproduction index. When apparent freezing of movement of subjects in a frame is required, which calls for short exposure times, LEDs cannot provide adequate illumination of the scene due to their low power rating. In comparison to LEDs, xenon flashguns have substantially better characteristics. A linear flash tube typically consists of a glass tube and two sealed electrodes, and is filled with a gas. It uses the principle of discharge, whereby between 40 and 60 percent of input electrical power is transformed into bursts of white light of short duration, mostly shorter than 1 ms.

Since 2017, the Godox A1 has been the only xenon flashgun intended for use with mobile devices available on the market.

The US20170195535A1 patent application describes the use of a xenon flash bulb in combination with a mobile device, the two devices communicating via a radio link. The system is configured in the way that enables the reception of a signal from a mobile device to remotely control the flashgun, whereby the signal includes at least the total light required from the flashgun to photograph the subject. The control system then adjusts the light emitted from the xenon flashgun according to the control signal. This solution describes the adjustment of the amount of light in single flashes.

The U.S. Pat. No. 7,949,249B2 patent describes the method to synchronize the camera on a mobile device with an external lighting apparatus. The solution describes the synchronization when a single flash of light is used to improve the lighting of a scene. The solution enables the use of a single flash by extending the sensor exposure time, thus creating an exposure window. In many situations, the extension of sensor exposure times is not desirable as it can lead to overexposure of the image or the blurring of fast-moving objects.

### STATE OF THE ART

The U.S. Pat. No. 6,009,281A patent describes a light source capable of emitting apparently uniform flashes of light. The device functions in connection with a camera with an in-built circuit to send signals on the selected mode of flash operation via electrical contacts

The U.S. Pat. No. 6,404,987B1 patent describes a system of external flashguns. In order to enable communication between the camera and the flashguns not mounted on the body of the camera, it uses a flash device mounted on the camera with a radio unit to control the remaining slave flash units. According to the invention, the radio unit features a circuit for the selection of the operation mode of the slave flash devices. The radio unit sends a signal to the external slave flash with the information on the selected operation mode.

### SUMMARY

The flashguns for mobile devices known to exist at the present time do not allow for optimal lighting because they only support the single flash emissions, therefore the purpose and objective of the present invention is to provide a light source that will make it possible to modulate its output.

### Description of the Solution to the Technical Problem

The task and objective of the invention is therefore to provide an external flash apparatus that may allow for the modulation of emitted light by establishing a radio link with a mobile device and emit single or apparently uniform flashes, which may in turn enable the adjustment of lighting depending of the natural lighting of the subject or scene to be photographed.

At the core of the invention is an external light source designed as an external flashgun for mobile devices, consisting of a xenon flash assembly with associated electronic circuitry, whereby the light source or flash is arranged to operate in at least two different modes, in a single flash mode and in an apparently uniform flash mode. One or several external light sources may be interlinked with a mobile device via radio links, with the external light source(s)s sending timestamps back to the mobile device in regular intervals. Based on these timestamps, the algorithm embedded in the mobile device's software is able to calculate the delay between the start of image capturing on the mobile device and the moment of triggering the flash of the external unit, which ensures uniform lighting of the entire subject.

Therefore, there is no need for use of light sources capable of apparent uniform emissions of the luminous flux throughout the time that the mechanical shutter curtain travels over the sensor. The apparent uniform intensity of the luminous flux is instead achieved by using a large number of short and quick bursts during the time that the mechanical shutter travels over the sensor of a DSLR or mirrorless camera.

A technical problem addressed by the invention presented herein is the design of a device ensuring optimal lighting of a selected subject captured by a still image camera integrated into a mobile device using for example a CMOS sensor, wherein adequate connectivity and time synchronization options are provided to interact with the functional (controlling) elements of a mobile device's still image camera.

Thereby, the quality of photographs captured by a mobile device come close to or even equal to that of single-lens reflect or mirrorless cameras. Even though cameras in mobile devices do not have lenses or sensors the size of those found in DLSR cameras, their practical advantages can offset the inferior quality (in purely technical terms) of the photos they produce. Mobile devices offer unparalleled options of instant processing of captured photographs allowing for the elimination of artefacts due to inferior sensors and optics. Moreover, unlike digital single-lens reflect (DSLR) or mirrorless cameras, mobile devices are ubiquitous and as such always close at hand to take instant photos of a desired subject or scene.

Optimum lighting may be provided in many situations, for instance when there is no exposure window.

The avoidance of a physical link between a light source and a camera may be desirable in many cases as it provides freedom of geometrical positioning of the camera and the flash unit.

The use of a flash device external to the camera body is desirable as it is easier to control the flashes when the camera itself features an integrated module for radio link with the external flash units.

An additional operation mode of the external light source is stroboscopic operation, which consists of a sequence of a large number of individual flashes. This mode allows for the creation of special visual effects.

Additionally, the mobile device is arranged to, based on the exposure time on the mobile device, send a signal to the external light source comprising the information on the selected operation mode.

As an extra option, the proposed flash apparatus may also feature an input button on its body allowing to actuate the capture of an image by the mobile device. When this input button is pressed, the external light source sends a signal to the mobile device, which will then take a photo. Furthermore, the input button or buttons placed on the body of the external light source may have varying functionality depending on the current state of the device. And finally, the unit's body may also feature a light indicator with at least three colors, preferably LEDs, which may display the current status of the unit by using different colors and blinking modes.

According to the invention, the external light source for mobile devices thus comprises:
a xenon flash with at least one flash tube and associated electronic circuit programmed to allow for the triggering of the flash tube in at least two operation modes:
   single flash mode, and
   apparently uniform flash mode;
an integrated circuit comprising a central processing unit (CPU) and a Bluetooth chip, wherein the CPU is programmed to:
   perform and control communication with the mobile device,
   perform and control the operation of the external light source, and
a switch connecting the capacitor and the flash tube in order to modulate the emission of flashes from the flash tube in dependence of the selected operation mode;
preferably an inertial measurement unit;
a multifunction input button to power the external light source on and off and, optionally, to trigger image capture, switch to another flash emitting mode or to reset the unit;
optionally a LED to provide auxiliary scene illumination, which:
   is installed in proximity of the flash tube and serving as a pilot light to assist with the directing of the optical axis of the flash,
   with its luminous flux helps the mobile device determine image capture parameters, primarily for correct focus on objects in the frame even in complete darkness,
   is powered and controlled by a LED controller, itself being controlled by the CPU;
optionally an indicator of the unit's status, preferably a multi-colored light, such as an RGBW LED, its primary task being to inform the user of the various states of the unit:
   the unit is on,
   low battery status,
   the unit is overheating,
   the battery is being charged correctly,
   the battery is fully charged.

The present invention relates to an external light source with an inbuilt (preferably) xenon flash, which operates in at least two modes. In the first mode it generates a single flash, while in the second mode, it generates an apparently uniform flash. Apart from xenon-filled flash tubes, there are also flashes containing other noble gasses, but they are not used for photography because the light spectrum they produce may not suited for such use. A simple swap of a LED light source for a xenon flash requires extensive adjustments because of the differences in their respective functioning, whereby electronic circuits supporting the operation of a flash consequently require a completely different design.

The electronic circuit that comprises the CPU and the Bluetooth chipset allows the external light source to generate a single flash. When the CPU receives the mobile device's signal comprising the information detailing the time of the photograph being captured and the power of the flash, the CPU establishes a connection with the control unit of the switch. The CPU sends to the control unit of the chip the signal comprising the information detailing the time of the photograph being captured and the required power of the flash. The controller of the switch calculates the time needed for the switch to remain open in order to reach the requested power of the flash. At the beginning of the photograph being captured, the control unit of the switch increases the voltage at the gate of the switch. The switch starts conducting power, which starts flowing from the capacitor into the flash tube. Once the envisaged time has elapsed, the control unit decreases the voltage at the gate of the switch, which then closes. The power of the flash thus depends on the duration of the switch being open. The result is a single flash that typically lasts less than 1 millisecond.

The electronic circuit also allows the generation of a so-called apparently uniform flash, which may comprise a sequence of a multitude of flashes. The flashes are characteristically relatively weak. There are many terms in English designating what we call apparently uniform flashes, such as: FP-sync, flat peak, uniform flash-emission, flat-emission, flat flash light, high speed synchro mode and High-Speed Sync (HSS) flash, the latter being the most commonly used term. Apparent uniform flashes have to be used below a given threshold sensor exposure time (flash sync speed or X-sync speed). These flashes are generated by high frequency toggles of the switch connecting the capacitor and the flash tube, which results in what appears to be a uniform flash, preferably lasting up to 25 milliseconds, or ideally with a duration ranging between 4 and 25 seconds.

Once the CPU receives a signal from the mobile device detailing the time of the photograph being captured, the power of the flash and its duration, the CPU will establish a connection with the control unit of the switch. The CPU then sends the control unit of the switch the signal detailing the time of the photograph being captured, the duration of the flash and its power. The controller calculates how the power at the gate of the switch may be modulated in order to reach the requested duration and power of the flash. At the start of the photograph being captured, the control unit of the switch starts modulating the voltage at the gate of the switch. The modulation typically uses frequencies above 15 kHz.

The third operation mode of the external light source is stroboscopic operation consisting of a sequence of a large number of individual flashes, which are limited in frequency and power so as to prevent overheating of the light source. The integrated circuit with the inbuilt CPU may switch the xenon flash to this operation mode. The user selects the stroboscopic operation mode via the user interface, as well as the desired frequency and power of the flashes. Via a radio link, the mobile device sends to the external light source the signal consisting of the information on the stroboscopic operation mode, the desired frequency and power of the flashes. Once the CPU receives from the mobile device the signal detailing the information relating to the start of the photograph being captured, power and frequency of the flashes, the CPU establishes a connection with the control unit of the switch. The controller calculates how the voltage at the gate of the switch may be modulated in order to reach the requested power and frequency of the flashes. At the start of the photograph being captured, the control unit of the switch starts modulating the voltage at the gate of the switch. The modulation typically uses frequencies below 100 Hz.

The switch is preferably of the isolated-gate bipolar transistor or IGBT type connecting the capacitor and the flash tube. Typically, one light source unit will feature a single flash tube and capacitor, so there is also only one switch built into the unit. One may also use RC or RLC circuit where the output power of the flash tube may be adjusted by changing the voltage of the main capacitor. The functioning of the IGBT switch is controlled by an IGBT switch controller. The CPU of the unit communicates with the controller and controls its operation. IGBT switches reduce the total luminous power emitted during a single flash by quickly closing the flow of electricity to the flash tube thus shortening the length of the flash without changing its amplitude. This is a desirable effect because it limits power consumption, while the quality of the light beam may be preserved. IGBT switches are used in all modern-day flash units.

The integrated circuit with the inbuilt CPU may be arranged to switch between the modes of operation of the xenon flash depending on the exposure time, which may be set in the user interface of the mobile device. The user may also let the mobile device calculate the exposure time. The mobile device may set the exposure time based on the intensity of light detected by its sensor. The switch between modes of operation occurs when the mobile device sends via a radio link a signal to the external light source setting either the use of a single flash and the power of the flash emitted in this operation mode, or setting the use of an apparently uniform flash and the power and length of the flash in this operation mode.

The central processing unit of the flash device, a component part of its integrated circuitry, may wait continuously for the signal comprising the information on the time to trigger the flash received from the mobile device via a radio link.

The linking of the external light source with a mobile device and the time synchronization of the light source with a mobile device may be enabled by an appropriate algorithm, which in its simplest implementation involves the following steps to be performed:
a) searching for a wireless devices in the vicinity, capable of emitting flashes;
b) establishing a wireless link with the external unit detected in step a);
c) sending a request about the time value to the external device that the mobile device connected with in step b);
d) in reply to the request under step c), the external wireless device sends a time value;
e) calculating of the time delay, which equals half of the time elapsed between the request for the time stamp of the external device until the receipt of the time value; and based on the time delay, calculating of the precise current time on the external device.

The time delay and the current time on the external device set according to the process described above are used to send the signal providing information on triggering time to the external device, and to send the request providing information on photo capturing time to the mobile device.

An example method to light a scene with the external light source for mobile devices comprises the following steps:
a) connection and time synchronization of the external light source with the mobile device;
b) in the case where the central processing unit receives the signal to switch the operation mode, the switch to the selected operation mode is made;
c) in the case when the input button on the external light source's housing is actuated, the flash's central processing unit sends a signal via the radio link to the operating system of the mobile device to capture the photograph;
d) in the case when the operating system of the mobile device receives the signal to capture a photograph, either by the device's own user interface or from the external light source:
   a. the time to capture the photograph is set in the operating system of the mobile device; and
   b. the mobile device's operating system sends the signal to the external light source comprising the information on the time to trigger the flash and on the power of the flash. In the apparently uniform flash mode, the external light source also receives information on the length of the flash. In the stroboscopic mode, information on the frequency of the flashes is also sent to the external light source.

The present invention of the external light source may additionally feature an inertial measurement unit, integrated into the electronic circuit within the body of the external light source. The CPU performs and controls communication with the inertial measurement unit. The flash units available until now that do not feature this sensor are not able to send signals to mobile devices comprising the information regarding the direction that the optical axis of the flash unit is facing. The signal detailing the information about the external light source's direction may allow the external light source to calculate the power of the flash required to achieve optimal lighting for the photograph. For instance, the mobile device may use the signals received from the external light source's CPU that the flash is pointing towards the ceiling, and may as a result increase the luminous power because based on an anticipated diffusion of the light beam.

The external light source for mobile devices used in conjunction with an adequately performing mobile device may allow for the capturing of photographs of comparable quality to the results obtained with a DSLR camera. At the same time, a photography system consisting of a mobile device and an external light source takes up much less space than comparable DSLR or mirrorless photography systems, making it much more portable.

Additionally, a single mobile device may connect to several external light sources. In such a case, the time synchronization may be performed with each external light source separately. In order to do this, data must be kept on the exact clock of each individual external light source, as well as data on the time delay of each individual external light source. Each of the external light source s may be set to any of the operation modes, but usually all of the units are set to the same operation mode. The setting may be set by the mobile device sending via a radio link to each external light source the signal that sets either the use of an individual flash and the power of the flash in this operation mode, or the use of an apparently uniform flash, the power and duration of the flash in this operation mode.

Following the establishment of the connection and time synchronization, the CPU of each individual external light source waits continuously for the signal to capture a photograph, which it may receive from:
a) the circuit detecting the actuation of the input button located on the body of the external light source; or
b) the mobile device via the radio link.

The setting may be set by the mobile device sending via a radio link to each external light source the signal that sets either the use of an individual flash and the power of the flash in this operation mode, or the use of an apparently uniform flash, the power and duration of the flash in this operation mode.

### BRIEF DESCRIPTION OF THE DRAWINGS

The present invention of a light source for mobile devices will be described below with the implementation examples and figures displaying:

FIG. 1 shows an isometric projection and view from below according to an implementation example

FIG. 2 shows a block diagram according to the implementation example

FIG. 3 is a diagram of a connection and time synchronization process according to the implementation example

FIG. 4 is a diagram of the subject/scene lighting process according to the implementation example.

### DETAILED DESCRIPTION

The general exterior design of the external lighting source according to the first implementation example is shown in FIG. 1. The external lighting source comprises a housing 1 with a window 2 for emitted light, The external lighting source may further comprise a status indicator 3. The external lighting source may further comprise a multifunction input button 4. The external lighting source may further comprise a charging port 5. The external lighting source may further comprise a mounting receptacle 6. The mounting receptacle 6 is in the illustrated example a hole with threads. In the illustrated example, the status indicator 3, the multifunction input button 4, the charging port 5 and the mounting receptacle 6 are arranged at the exterior of the housing 1.

The housing 1 also features the following elements either comprised inside or located on its exterior:
a linear flash tube, which emits light through the appropriately shaped housing window 2. The flash tube operates in at least two modes:
   an single flash mode. The power settings of the single flash mode may range from the maximum flash power to 1/512 of maximum possible flash power,
   an apparent uniform flash mode. The duration of the flash may be up to 40 ms, and preferably between 4 ms and 25 ms.
   optional stroboscopic operation mode.th preferably frequencies up to 100 Hz;
a source of electrical power, such as an integrated battery;
an electronic circuit to deliver power to the flash tube;
an IGBT switch controller and the IGBT switch;
integrated circuit with a central processing unit (CPU) and a built-in Bluetooth chip;
an inertial measurement unit (IMU);
a charging port, preferably a USB-C female connector;
a multi-function input button to power the device on and off, to trigger the capturing of a photo, to switch between operation modes or to reset the device;
a RGBW LED to model light, as auxiliary light or as a source of lighting for video recording.

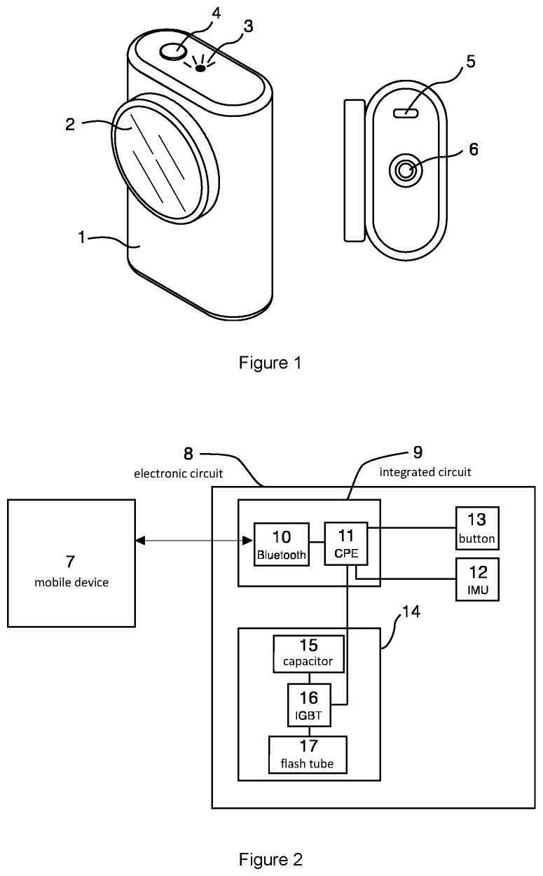

FIG. 2 displays the block diagram according to the implementation example, which comprises a mobile device 7; an electronic circuit 8 of an external light source comprising an integrated circuit 9, wherein the integrated circuit 9 comprises a Bluetooth chip 10 and a central processing unit 11; an inertial measurement unit (IMU) 12 arranged to detect spatial orientation; an input button 13; and electronic circuit 14 for supplying power to a flash tube 17, which includes at least:
a capacitor 15, preferably with a capacitance between 500 and 1500 microfarads,
a source of electrical power, such as an integrated battery,
a transformer to transform voltage of the integrated battery to high voltage; preferably in the range between 300 and 400 volts,
a controller for the charging of the capacitor 15,
an IGBT switch controller and an IGBT switch 16,
a xenon flash tube 17.

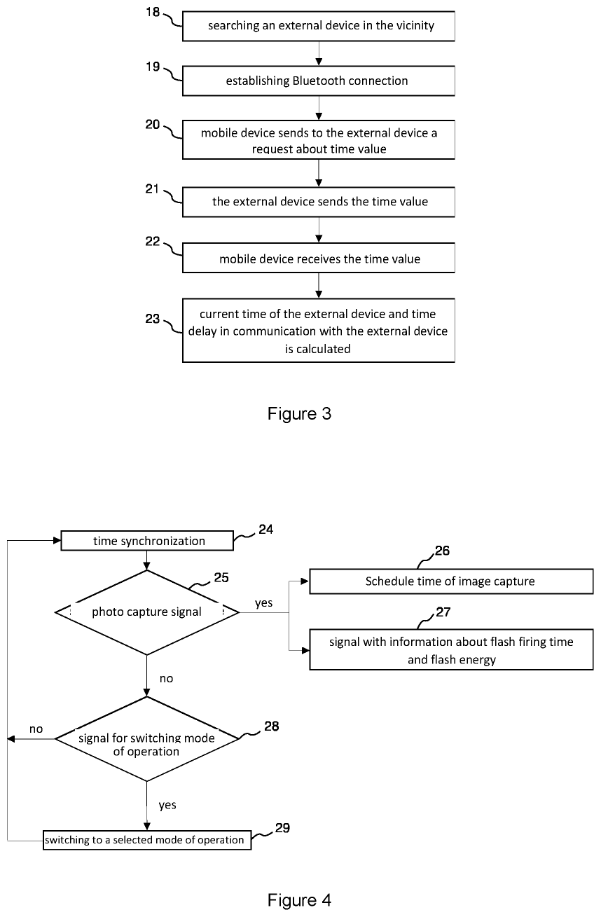

FIG. 3 displays the diagram of a connection and time synchronization process according to the implementation example. The mobile device first searches for the external light source in Step 18 and connects to it in Step 19. The search and connection between the mobile device and the external light source makes use of the Bluetooth chip and of the corresponding components in the mobile device to enable a Bluetooth connection. Then the mobile device sends its request for the time value to the connected device in Step 20. The external unit then replies to the request and sends back its time value in Step 21. The mobile device receives the time value in Step 22. Based on the time elapsed between the request for the time value having been sent to the external unit and the received time value, the mobile device determines in Step 23 the exact current time on the external unit and the time delay that has to be taken into account in communication with the external unit. Steps from 20 to and including 23 are intended for time synchronization between the external unit and the mobile device.

FIG. 4 displays the process of lighting a subject or a scene according to the implementation example. Step 24 consists of the time synchronization between a mobile device and the external light source as described in Steps 20 through 23. The operating system receives a signal to capture a photo:
via a Bluetooth link from the central processing unit of the external light source after the input button on its housing has been actuated; or
from the user interface of the mobile device.

The mobile device's operating system upon receiving a signal to capture a photograph in Step 25, schedules the capture of the photo for a point in time in Step 26, and substantially simultaneously in Step 27 send to the external light source the signal detailing the information on the flash triggering time and on the power of the flash. If the external light source is set to the apparent uniform flash mode, the signal sent to it also comprises information relating to the duration of the flash. If the external light source is set to the stroboscopic operation mode, the signal sent to it also comprises information relating to the frequency of the flashes. If the mobile device sends to the external light source a signal to switch operation modes in Step 28, then the external light source will switch to the selected mode in Step 29. At the moment of the photo capture initiation, the process of triggering the flash is as follows: the CPU of the external light source sends the information on the modulation parameters to the IGBT switch controller, which in turn starts modulating the voltage at the IGBT gate. Consequently, the charged capacitor will connect once or several times with the flash tube, which will emit a single flash or multiple flashes, depending on the operation mode set in Step 28.

1. An external light source for mobile devices, comprising a housing having a window for light emitted by the external light source, wherein installed inside the housing are at least the following components:
a xenon flash with at least one flash tube and associated electronic circuit comprising a capacitor, wherein the circuit is configured to allow for triggering of the xenon flash tube in at least two operation modes:
a single flash, and
an apparent uniform flash;
integrated circuit with a central processing unit and Bluetooth chip, wherein the CPU is configured to perform at least:
communication with a mobile device via a radio link, and
control of the operation of the external light source; and
switch, and a control unit of the switch via which the CPU communicates to trigger the flash tube in accordance with the selected operation mode,
wherein the integrated circuit and the switch are arranged to provide a flash in the single flash operation mode of less than 1 millisecond duration via said flash tube, and
wherein the integrated circuit and the switch are arranged to provide an apparent uniform flash in the apparent uniform flash operation mode of at least 4 milliseconds duration via said flash tube.

2. An external light source for mobile devices according to claim 1, further comprising an input button arranged at the housing of the external light source, the input button configured to at least one of initiate the capture of a photograph, switch between operation modes or reset the external light source.

3. An external light source for mobile devices according to claim 1, further comprising a first LED for auxiliary lighting of the scene:
which is located near the flash tube and serves as a pilot light to assist with the setting of the optical direction of the external light source;
which with emitted luminous flux of the first LED assists the linked mobile device to set the parameters for the capture of photographs; and
to which an LED controller supplies and manages power for operation, said LED controller being controlled by the CPU.

4. An external source of light according to claim 1, further comprising an inertial measurement unit, built into the electronic circuit located inside the housing of the external source of light, whereby the CPU performs and controls communication with the inertial measurement unit, so that the external light source is able to determine the direction of its optical axis.

5. An external source of light for mobile devices according to claim 1, further comprising an indicator of the unit's status.

6. A system comprising a mobile device and an external light source for the mobile device according to claim 1, wherein the external light source for the mobile device enables connections to the mobile devices via an algorithm embedded in integrated circuitry of the mobile device, which performs at least the following steps:
a) searching for nearby wireless devices capable of producing flashes;
b) establishing a wireless connection with the external unit found in Step a);
c) sending the request for a time value to the external device that the mobile device connected to in Step b);
d) as a response to the request in Step c), the external wireless unit sends a time value; and
e) calculating the time delay, which equals half of the time elapsed from the request for a timestamp on the external unit to the receipt of the time value; and based on the time delay, the calculation of the exact time on the external unit.

7. An external light source for mobile devices according to claim 1, wherein in the single flash mode, the CPU is configured to calculate how to modulate the voltage on the gate of the switch to achieve the required power of the flash, based on which the voltage on the gate of the switch is adjusted and, consequently, enable the flow of energy from the capacitor into the flash tube for a pre-set time period.

8. (canceled)

9. An external light source for mobile devices according to claim 1, wherein the controller control unit of the switch further calculates the duration and power of the flash so as to enable the control unit to toggle the switch connecting the capacitor to the flash tube at a certain frequency, the result of which is an apparent uniform flash with a duration of at least 25 milliseconds.

10. An external light source for mobile devices according to claim 1, further comprising a third mode of operation, which is the stroboscopic mode of operation, wherein the flash tube emits a sequence of a large number of individual flashes at the desired frequency and power.

11. An external light source according to claim 1, further comprising an electrical power source.

12. The external light source according to claim 1, wherein the apparent uniform flash is a sequence of multiple flashes.

13. A method of using the external light source according to claim 1 in conjunction with a mobile device.

14. A method for lighting a scene using external flash for mobile devices, comprising the following steps:
providing wireless connection and time synchronization between an external light source and a mobile device via a radio link;
in the case wherein the central processing unit receives the signal to switch an operation mode, switching to the selected mode of operation of the external light source is carried out;
in the case wherein the input button located on the housing of the external light source is actuated, the central processing unit of the external light source sends a signal to the operating system of the mobile device via the radio link, to capture a photograph;
in the case wherein the operating system of the mobile device receives the signal to capture a photograph, either from the user interface of the mobile device itself or from the external light source:
the capture of a photograph is scheduled within the operating system of the mobile device; and
a signal on the time to trigger the flash is sent to the external light source.

15. The method according to claim 14, wherein the central processing unit of the external light source, after having established the connection and performed time synchronization, waits to receive the signal to capture a photograph:
either from the circuit detecting the actuation of the input button located on the housing of the external light source; or
from the mobile device via the radio link,
whereby the signal to capture a photograph also comprises the information relating to the time to trigger the flash.

16. An external light source for mobile devices according to claim 1, wherein the switch comprises an IGBT switch connecting the capacitor and the flash tube.

17. An external light source for mobile devices according to claim 3, wherein emitted luminous flux assists the linked mobile device to set the parameters for the capture of photographs to focus on objects in a frame even in complete darkness.

18. An external light source for mobile devices according to claim 5, wherein the indicator comprises a multi-colored lamp.

19. An external light source for mobile devices according to claim 18, wherein the multi-colored lamp comprises a RGBW LED.

20. An external light source for mobile devices according to claim 5, wherein the indicator is configured to communicate to the user one or more states of the external source light, the one or more states comprising at least one of:
the external source of light is on;
low battery status;
the external source of light is overheating;
the battery is being charged correctly; or
the battery is fully charged.

21. An external light source for mobile devices according to claim 11, wherein the electrical power source comprises at least one of an integrated battery or a charging port.
